(19) United States
(12) Patent Application Publication
(10) Pub. No.: US 2026/0338068 A1
(43) Pub. Date: Oct. 29, 2026

(54) Flexible Hollow Anchor Rod Integrating Digital Monitoring and Construction Method Thereof

(71) Applicants: CHINA UNIVERSITY OF MINING AND TECHNOLOGY, Jiangsu (CN); XUZHOU UNIVERSITY OF TECHNOLOGY, Jiangsu (CN); JIANGSU FENGZHI MINING TECHNOLOGY CO., LTD, Jiangsu (CN)

(72) Inventors: Zhengzheng XIE, Jiangsu (CN); Yongle LI, Jiangsu (CN); Nong ZHANG, Jiangsu (CN)

(21) Appl. No.: 18/998,926

(22) PCT Filed: Jan. 25, 2024
(86) PCT No.: PCT/CN2024/073921

§ 371 Date: Jan. 27, 2025

(30) Foreign Application Priority Data
Oct. 17, 2023 (CN) 202311337013.3

(51) Int. Cl. E21D 21/00; E21D 20/02; E21F 17/18; G01L 1/24

(52) U.S. Cl. CPC E21D 21/0026; E21D 20/02; E21F 17/18; G01L 1/246

(57) ABSTRACT

Disclosed is a flexible hollow anchor rod integrating digital monitoring and a construction method thereof. The present disclosure can realize real-time monitoring of the anchor rod condition by using a fiber grating sensor, and has the advantages of rapid installation, convenient grouting, and high anchoring quality, etc.

### TECHNICAL FIELD

The present invention belongs to the technical field of coal mine roadway support, in particular to a flexible hollow anchor rod integrating digital monitoring and a construction method thereof.

### BACKGROUND ART

With the development of intelligent excavation and the trend of deep coal mining, higher requirements are put forward for roadway excavation support. Firstly, an objective is to realize safe and efficient maintenance and control of roadways under complex conditions; for example, deep roadways are facing a series of severe difficulties such as serious deformation, intense mine pressure in the stope and frequent dynamic disasters. Secondly, another objective is to improve roadway excavation speed and realize real-time monitoring and feedback of roadway support condition. Building up an intelligent rapid excavation system is an inevitable way for intelligent development of coal mines at present.

Anchor rod support is the main support form for coal mine roadways in China. However, limited by the narrow spaces in roadways, the maximum anchoring depth of rigid anchor rods is 2.4-2.8 meters, making it difficult to anchor into a deep stable rock formation, resulting in weak foundation bearing circles and frequent roof collapse accidents. Although anchor cables can overcome the drawbacks of small anchoring depth and low strength, their installation process is relatively complicated, and it is unable to realize timely support after excavation with anchor cables, resulting in low construction efficiency and the excavation speed being seriously limited. In order to solve the above problems, a construction method for flexible anchor rods having a relatively simple installation process has appeared in the prior art. But it still has the problems of a large quantity of components and complicated supporting steps, and involves an eccentric anchoring problem, i.e., the anchor rod/cable is not at the center of the drill hole during the anchoring process, resulting in a maximum anchoring force loss of up to 30%.

For fractured rock masses, it is difficult to realize stable control of the roadways solely by means of anchor rod/cable support. By using anchor rod/cable support in combination with grouting reinforcement to modify and reinforce crushed surrounding rocks, the supporting strength and bearing capacity of the surrounding rocks can be significantly improved, thus more complex roadway environments can be better dealt with. At present, roadway bolting and grouting control is mainly realized by means of hollow grouting anchor rods/cables, and most hole grouting and sealing devices employ a squeeze sealing approach, in which the hole sealing device is separate from the anchor rod body. For example, the structure is disclosed in Chinese patent which has a Publication No. of CN218563629U, published on Mar. 3, 2023 and entitled “Embedded Expansion Hole Packer for Hollow Grouting Mine Anchor Cable”, and this structure involves a complicated operation process, and has a low hole sealing success rate and a poor hole sealing effect.

Anchor rod stress monitoring is one of the main indicators for evaluation of the roadway support condition. An existing dynamometer can only monitor the local stress in the exposed end of the anchor rod. Along with the application of optical fibers in coal mines, the stress in anchor rod body can be monitored by means of optical fibers, and the monitoring accuracy and sensitivity are higher. Optical fibers can be arranged mainly by grooving in anchor rod bodies or attaching to anchor rod bodies from outside. For example, as described in Chinese Patent Publication No. CN113267127B which is published on Mar. 8, 2022 and titled as “Fiber Grating Sensing Safety Monitoring System for Roadway Surrounding Rock Which Takes Anchor Rod as Sensing Medium”, optical fibers are arranged by grooving in anchor rod bodies. However, since the strength of the anchor rod body is decreased due to grooving, consequently the anchoring strength will be affected; if the optical fiber is arranged outside the anchor rod body, the diameter of the anchor rod body will be increased, and the optical fiber may be rubbed by the hole wall, leading to optical fiber breakage, consequently the monitoring process cannot be implemented.

### SUMMARY OF THE INVENTION

In view of the problems existing in the prior art, the present invention provides a flexible hollow anchor rod integrating digital monitoring and a construction method thereof. The anchor rod can be installed rapidly while meeting the requirements for the length and strength of support, and is helpful for greatly improving roadway excavation efficiency, building up a high-quality support system, realizing real-time monitoring of the support condition, and effectively ensuring safe production operation in coal mines. The method involves simple construction steps, has a low implementation cost, can achieve an ideal support effect, supports real-time monitoring of the support condition, and is conducive to building up a high-quality support system.

In order to achieve the above objects, the present invention provides a flexible hollow anchor rod integrating digital monitoring, which comprises a flexible hollow rod body, a hole sealing sheath, an anti-torsion tray, a ribbed tray, a self-aligning ball head, an anti-wear gasket, a torque nut and a fiber grating sensor;
the flexible hollow rod body consists of a hollow anti-torsion sleeve, a grout stop ring, a friction-increasing wire spring, a steel strand, a hollow steel tube, a grout stop plug and a centering positioner;
the left half part of the hollow anti-torsion sleeve is a fastening section, the right half part of the hollow anti-torsion sleeve is an anti-torsion connecting section, the cross section of the outer contour of the anti-torsion connecting section is a regular polygon structure, a strip-shaped through groove is formed in each surface of the outer contour of the anti-torsion connecting section, a rod body mounting cavity is formed at the axis of the anti-torsion connecting section; the outer contour of the fastening section is a cylindrical structure, a first external thread structure is formed on the outer contour of the fastening section, a core tube mounting hole is formed at the axis of the fastening section, and a section of internal thread structure is formed inside a left end of the core tube mounting hole; a right end of the core tube mounting hole is in communication with a left end of the rod body mounting cavity;
the outer diameter of the grout stop ring matches the inner diameter of the rod body mounting cavity, and the grout stop ring is coaxially assembled in the left end of the rod body mounting cavity;
the outer diameter of the friction-increasing wire spring matches the inner diameter of the rod body mounting cavity, and the friction-increasing wire spring is coaxially assembled in the rod body mounting cavity and located at the right side of the grout stop ring;
the steel strand is formed from a plurality of steel wires spirally wound together, with a central cavity formed at the axis; a pin is radially inserted into a middle section of the steel strand, and a grout passage for communicating the central cavity with the external space is reserved by means of the inserted pin;
the left section of the hollow steel tube is a main body mounting section, and a section of the hollow steel tube on the right of the main body mounting section is a rod body mounting section; the rod body mounting section of the hollow steel tube is fixedly inserted into the central cavity of the steel strand, and has a grout outlet arranged at a position corresponding to the grout passage; the hollow steel tube and the steel strand jointly form the flexible hollow rod body after they are connected together;
the left part of the formed flexible hollow rod body is inserted into the rod body mounting cavity inside the hollow anti-torsion sleeve, the left end of the steel strand is inserted into a spring cavity of the friction-increasing wire spring, and is fixedly connected with the anti-torsion connecting section through mutual squeezing action with the friction-increasing wire spring; besides, the main body mounting section of the hollow steel tube is fixedly inserted into the core tube mounting hole after passing through the grout stop ring, and the left end of the main body mounting section is stopped at the right side of the right end of the internal thread structure;
the external surface of the plug body of the grout stop plug is provided with a second external thread structure, and the grout stop plug is assembled at the left end of the core tube mounting hole through thread-fitting between the second external thread structure and the internal thread structure;
the centering positioner consists of a positioning sleeve and three positioning clips, the three positioning clips are evenly distributed in an annular shape, the left ends thereof are evenly fixedly connected to the edge of the right end of the positioning sleeve in a circular manner, and the centering positioner is fixedly fitted around the outside of the right end of the steel strand via the positioning sleeve;
the hole sealing sheath is made of an elastic sealing material, and consists of a continuous fluctuation section on the left and a tapered section on the right, and the hole sealing sheath is sleeved outside a transition area where the hollow anti-torsion sleeve is connected with the flexible hollow rod body, wherein the outer contour of the continuous fluctuation section is a continuous fluctuation type changing structure, and the continuous fluctuation section is sleeved outside the anti-torsion connecting section, the outer contour of the tapered section is a tapered structure whose outer diameter is reduced gradually from left to right, and the tapered section is sleeved outside the steel strand;
the anti-torsion tray consists of a central tray body and four stop posts, the tray body is a flat plate structure, a regular polygonal anti-torsion mounting hole that matches the outer contour shape of the anti-torsion connecting section is formed at the center of the tray body, four positioning notches are evenly arranged in circumferential on an outer edge surface of the tray body, and four positioning bumps are formed between the four positioning notches; the four stop posts are evenly distributed in circumferential around the anti-torsion mounting hole and arranged in one-to-one correspondence with the four positioning bumps, and each stop post is vertically and fixedly connected to a corresponding positioning bump; the anti-torsion tray is sleeved outside the left end of the anti-torsion connecting section through the anti-torsion mounting hole, and the four stop posts are located on the right side of the central tray body;
the ribbed tray consists of a main body part located in the central area and a supporting part located on the periphery of the main body part, the main body part protrudes gradually from the periphery to the center in a direction away from the supporting part, and forms eight raised longitudinal ribs evenly in the circumferential direction; besides, a bearing part parallel to the supporting part is formed in the central area of the eight raised longitudinal ribs, eight octagonal grooves are evenly formed on inner edges of the eight raised longitudinal ribs, and the size of a space formed inside the eight raised longitudinal ribs matches the size of the central tray body; a small through hole is formed in a side of the main body part; a ball head positioning hole is formed at the center of the bearing part, and the center of the ball head positioning hole is recessed in a ball socket form in a direction getting close to the supporting part; the ribbed tray is fitted around the outside of the fastening section through the ball head positioning hole, and four non-adjacent octagonal grooves in the inner surface of the ribbed tray are positioned and fitted with the four bumps on the anti-torsion tray;
the self-aligning ball head is a hemispherical structure, with an anchor hole formed at the axis, the self-aligning ball head is fitted around the fastening section through the anchor hole, and a spherical part of the self-aligning ball head is inserted into the ball head positioning hole;
the anti-wear gasket is fitted around the outside of the fastening section and is snugly connected with a planar part of the self-aligning ball head;
the torque nut is assembled outside the fastening section through thread-fitting between the internal thread structure of the torque nut and the first external thread structure, and sequentially presses the anti-wear gasket, the self-aligning ball head and the ribbed tray located on the right side thereof toward the anti-torsion tray;
the fiber grating sensor consists of an optical fiber and a plurality of optical gratings arranged on the optical fiber; three fiber grating sensors are evenly arranged in circumferential, and each fiber grating sensor is embedded and bonded in a spiral mounting groove formed between two adjacent steel wires, the right end of the fiber grating sensor extends to the left end of the centering positioner, and the left end of the fiber grating sensor is terminated at the right end of the hollow anti-torsion sleeve; three fiber output sections correspondingly connected to the three fiber grating sensors pass through three strip-shaped through grooves and then enter into the inner cavity of the ribbed tray, and are led out of the ribbed tray through the small through holes.

Preferably, the outer contour of the anti-torsion connecting section has a regular hexagon shape, and six strip-shaped through grooves are evenly arranged on the outer contour of the anti-torsion connecting section in the circumferential direction, wherein the three fiber output sections correspondingly connected to the three fiber grating sensors are arranged in the three strip-shaped through grooves in a manner that every two of them are not adjacent to each other.

Preferably, the outer diameter of the fastening section is smaller than the outer diameter of the anti-torsion connecting section, the hollow anti-torsion sleeve is provided with an annular transition boss between the fastening section and the anti-torsion connecting section, and the outer diameter of the annular transition boss is greater than the outer diameter of the fastening section and smaller than the outer diameter of the anti-torsion connecting section.

Preferably, the cross section of the bore of the continuous fluctuation section has a regular polygon shape that matches the outer contour of the anti-torsion connecting section, and the outer contour of the continuous fluctuation section is a multi-sectioned continuously-arranged drum structure, and the cross section of the bore of the tapered section has a circular shape that matches the outer contour of the steel strand.

Preferably, the stop posts are fixedly connected to the positioning bumps by means of bonding or welding.

Furthermore, in order to conveniently check the stress state of each part of the anchoring section in real time, the flexible hollow anchor rod further comprises a fiber grating demodulator, which is connected to the fiber output sections of the three fiber grating sensors respectively.

Furthermore, in order to ensure good service life of the anti-wear gasket, the anti-wear gasket is made of polytetrafluoroethylene (PTFE) material.

In order to effectively hold the anchoring agent and significantly improve the stirring effect, the size of an annular space enclosed by the three positioning clips is consistent with the inner diameter of the positioning sleeve, and the dimension of the outer edges of the three positioning clips are greater than the outer diameter of the positioning sleeve.

In order to improve the sealing effect while ensuring good service life of the hole sealing sheath, the hole sealing sheath is made of rubber material.

In the present invention, a core tube mounting hole and a rod body mounting cavity that are in communication with each other are arranged at the axis of the hollow anti-torsion sleeve, so that when the left end of the steel strand is inserted into the rod body mounting cavity, an exposed main body mounting section of the hollow steel tube can be inserted into the core tube mounting hole, thereby a grouting function can be realized by using the core tube mounting hole in coordination with the main body mounting section of the hollow steel tube. A friction-increasing wire spring is arranged between the steel strand and the hollow anti-torsion sleeve, and the friction-increasing wire spring can be used to significantly improve the friction force, so as to ensure that the steel strand can be firmly connected to the inside of the anti-torsion sleeve by buckling, and the bearing capacity of the connection can be effectively ensured. A grout stop ring is fitted at the left end of the rod body mounting cavity, and the root of the main body mounting section of the hollow steel tube is inserted into the grout stop ring, so that the gap between the outer round surface of the hollow steel tube and the inner round surface of the rod body mounting cavity can be plugged by the grout stop ring, thereby the grout injected into the steel strand can be effectively prevented from overflowing from the gap between the core tube mounting hole and the hollow steel tube. By inserting a pin in the middle section of the steel strand radially, a grout passage can be reserved among the plurality of steel wires by means of the pin, and the grout passage can be effectively prevented from being buried by the steel wires; due to the hollow steel tube having a grout outlet inside the steel strand, it ensures that the grout entering the central cavity can smoothly flow out of the steel strand through the grout passage, thereby the gap between the steel strand and the wall of the drill hole can be effectively filled with the grout; thus, the flexible hollow rod body can be firmly fixed in the drill hole after the grout solidifies. A centering positioner is assembled in the tail end of the steel strand, and three positioning clips are evenly arranged on the right end of the centering positioner; thus, the anchoring agent can be positioned and pulled conveniently, and can be stirred extensively in the rotation process by means of the positioning clips; moreover, the flexible hollow rod body can be positioned in the central area of the drill hole in the stirring process, thereby the injected grout can be uniformly filled in the gap between the rod body and the drill hole, the anchoring force can be significantly improved, and a high-quality support system can be built up. The outer contour of the anti-torsion connecting section of the right half part of the hollow anti-torsion sleeve has a regular polygon shape, and the anti-torsion mounting hole at the center of the anti-torsion tray has a regular polygon shape that matches the shape of the anti-torsion connecting section; thus, when the anti-torsion tray is fitted around the outside of the anti-torsion connecting section on the hollow anti-torsion sleeve, no relative rotation between the anti-torsion tray and the hollow anti-torsion sleeve will occur. Since four stop posts are vertically and fixedly connected around one side of the anti-torsion tray, in the actual installation process, rotation of the flexible hollow rod body in the pre-tightening process can be effectively avoided simply by using the locking force provided by the torque nut to press the four stop posts on the anti-torsion tray against the surface of the rock wall, thereby greater pre-tightening force can be applied, and the supporting effect is greatly improved. The fastening section on the left half part of the hollow anti-torsion sleeve is a cylindrical structure, and is provided with a first external thread structure; thus, the ribbed tray, the self-aligning ball head and the torque nut can be conveniently fitted on the fastening section, and a pre-tightening force can be easily exerted by means of the torque nut through thread-fitting; a strip-shaped through groove is formed on each surface of the outer contour of the anti-torsion connecting section; thus, the optical fiber output section of the fiber grating sensor arranged on the surface of the steel strand can be embedded in the strip-shaped through groove, and damages to the optical fiber resulted from foreign objects rubbing the optical fiber can be effectively avoided. A section of internal thread structure is arranged in the core tube mounting hole at the end of the fastening section, and the surface of the plug body of the grout stop plug is provided with a second external thread structure, so that the grout stop plug can be stably assembled to the end of the core tube mounting hole through thread-fitting, thereby the grouting passage can be effectively plugged, so that a situation of grout overflow after grouting is avoided. By wrapping the hole sealing sheath around the outside the joint between the steel strand and the hollow anti-torsion sleeve, the grout will not overflow from the joint during grouting, and the gap between the anchor rod and the drill hole can be effectively plugged by means of the outer contour of the hole sealing sheath which is expanded under a squeezing action, thereby the grout will not overflow from the gap between the drill hole and the anchor rod, and an integrated overall hole sealing operation can be realized; the right end of the continuous fluctuation section is configured as a tapered section, which is beneficial for effectively plugging the diameter-varied transition part of the drill hole in the installation process. Eight raised longitudinal ribs are evenly arranged on the outer surface of the main body of the ribbed tray in the circumferential direction, so that the bearing capacity of the ribbed tray can be effectively improved and a higher pre-tightening force can be advantageously applied to the anchor rod; besides, since such a tray with the raised longitudinal rib structures can provide greater bearing capacity, a lighter ribbed tray can be used to replace the traditional butterfly tray under the same support requirements, so as to reduce the labor load of the underground workers; eight octagonal grooves are evenly arranged on the inner surface of the ribbed tray in the circumferential direction, so that four of the octagonal grooves can be conveniently used for positioning and fitting with four positioning bumps on the periphery of the anti-torsion tray; thus, when the four stop posts on the anti-torsion tray are pressed against the rock wall, the rotation can be avoided in the process of applying the pre-tightening force by cooperating with the anti-torsion tray. The main body is provided with a small through hole, so that the output ends of the fiber grating sensors can penetrate into the external space for connection with a fiber grating demodulator. The self-aligning ball head is configured as a hemispherical structure, and a socket-shaped ball head positioning hole is formed at the center of the ribbed tray, so that the spherical part of the self-aligning ball head is always in annular linear contact with the ball head positioning hole of the ribbed tray during the process of applying the pre-tightening force, thereby the purpose of automatic self-aligning is attained, the ribbed tray will not deviate from the predetermined mounting position in the process of applying the pre-tightening force; thus, the construction quality can be improved, and the supporting effect can be ensured. The anti-wear gasket arranged between the torque nut and the planar part of the self-aligning ball head is beneficial to protection of the torque nut and the self-aligning ball head in the process of applying the pre-tightening force, and a situation that the supporting strength is compromised owing to mutual damage can be avoided. Since the fiber grating sensors are arranged in the spiral mounting grooves formed between adjacent steel wires on the outer surface of the steel strand, the stress in the effective anchoring rod body can be monitored along the entire length, so as to ascertain the stress condition of the effective anchoring rod body in real time; moreover, a situation that the strength of the rod body is reduced as a result of direct grooving in the surface of the rod body can be avoided, without increasing the diameter of the rod body, thus the anchoring force of the rod body is effectively ensured. In addition, since three fiber grating sensors are evenly distributed on the surface of the steel strand, a situation of missed detection, which may easily occur in the traditional scheme using only one fiber grating sensor, can be avoided effectively.

The present invention further provides an installation method of the flexible hollow anchor rod integrating digital monitoring, which uses a flexible hollow anchor rod integrating digital monitoring and comprises the following steps:
step 1: drilling a stepped drill hole in a rock mass, wherein the stepped drill hole consists of a large-diameter section of drill holes proximal to the surface of the rock mass and a small-diameter section of drill holes distal to the surface of the rock mass, the pore diameter and length of the large-diameter section of drill holes match the pore diameter and length of the hole sealing sheath, and the pore diameter and length of the small-diameter section of drill holes match the pore diameter and length of the steel strand;
step 2: first, arranging the three fiber grating sensors whose length match the length of the steel strand evenly on the outer surface of the steel strand in the circumferential direction, and bonding each fiber grating sensor in the spiral mounting groove formed between every two adjacent steel wires, and embedding the three fiber output sections correspondingly connected to the three fiber grating sensors in the three strip-shaped through grooves on the hollow anti-torsion sleeve at the same time; then, sleeving the hole sealing sheath outside the hollow anti-torsion sleeve; next, fitting the anti-torsion tray around the left end of the hollow anti-torsion sleeve, so that the stop posts are located at a side close to the hole sealing sheath;
finally, fitting the ribbed tray, the self-aligning ball head, the anti-wear gasket and the torque nut around the fastening section sequentially, so that the self-aligning ball head is embedded in the ball head positioning hole;
step 3: first, placing an anchoring agent in the stepped drill hole, then using the centering positioner fixed at the end of the flexible hollow rod body to press the anchoring agent and push the anchoring agent to the bottom of the stepped drill hole; next, starting an anchor rod drill to drive the torque nut to rotate and synchronously drive the flexible hollow rod body to rotate, and then using the three positioning clips on the centering positioner to stir the anchoring agent; driving the anchor rod drill to move further toward the bottom of the hole to evenly stir the anchoring agent while the flexible hollow rod body rotates; waiting for 30 seconds after the anchor rod drill is driven to the bottom of the hole, so that the anchoring agent fully solidifies;
step 4: switching on the anchor rod drill again to destroy a pin piece on the torque nut to make the torque nut rotate toward the bottom of the hole along the first external thread structure on the fastening section and press against the anti-wear gasket and the self-aligning ball head, thereby driving the ribbed tray and the anti-torsion tray to move in the axial direction of the fastening section toward the bottom of the hole, so that the four stop posts on the anti-torsion tray are pressed against the rock wall, using the anti-torsion tray to drive the hole sealing sheath to move toward the bottom of the hole, and pushing the tapered section of the outer contour of the hole sealing sheath into the joint between the large-diameter drill hole and the small-diameter drill hole; in this process, positioning the hollow anti-torsion sleeve and the ribbed tray in the rotation direction by using the positioned anti-torsion tray, plugging the transition between the large-diameter drill hole and the small-diameter drill hole with the tapered section of the outer contour of the hole sealing sheath, and, at the same time, sealing the large-diameter drill hole with the continuous fluctuation section of the outer contour of the hole sealing sheath that has expanded in volume owing to a squeezing action;
step 5: withdrawing the anchor rod drill, then repeating the steps 1-4 to perform the installation operation of the flexible hollow anchor rod sequentially;
step 6: for each flexible hollow anchor rod, removing the grout stop plug from the hollow anti-torsion sleeve, mounting a grouting pipe at the core tube mounting hole at the axis of the fastening section, and grouting through the grouting pipe; wherein grouting is not carried out immediately after the installation of the flexible hollow anchor rod, because the factures in the surrounding rock of the roadway has not fully developed at this time; instead, grouting is carried out after the stress of the roadway is completely relieved and a new balance is achieved, at this time the fractures has developed to a certain degree but are not in communication with each other yet and the stability of the surrounding rock can be maintained; by controlling the grouting time accurately and utilizing a delayed grouting operation, the injected grout can flow through the core tube mounting hole, the hollow steel tube and the grout outlet on the hollow steel tube and enters the central cavity of the steel strand, and then the injected grout is filled through the grout passage on the steel strand into the space between the steel strand and the small-diameter section of drill holes; after the grouting, mounting the grout stop plug to the left end of the core tube mounting hole through thread-fitting to reset the grout stop plug, so as to effectively block the grout and close the fractures in the rock mass;
step 7: connecting the three fiber output sections correspondingly connected to the three fiber grating sensors on each flexible hollow anchor rod to a fiber grating demodulator, so as to monitor the stress in each flexible hollow anchor rod with the fiber grating demodulator.

In the present invention, a stepped drill hole is drilled in the rock mass, so that a small-diameter section of drill holes can be used for accommodating the flexible hollow rod body, while a large-diameter section of drill holes can be used for accommodating the hollow anti-torsion sleeve sleeved with the hole sealing sheath; three fiber grating sensors are evenly arranged on the surface of the steel strand, and each fiber grating sensor is bonded in a spiral mounting groove formed between every two adjacent steel wires, so that the anchor rod can be provided with a stress monitoring function, thereby stress monitoring for the rod body along the entire length can be realized, without increasing the outer diameter of the rod body or damaging the structure of the rod body. After the anchoring agent is loaded into the drill hole, the anchoring agent can be stirred extensively with the three positioning clips on the central locator, so that the anchoring effect can be significantly improved. In the process of applying pre-tightening force, the self-aligning ball head is used to push the ribbed tray to move toward the bottom of the hole, so as to achieve the purpose of automatic self-aligning, thereby the ribbed tray will not deviate from the predetermined mounting position during application of the pre-tightening force, and the construction quality can be improved. The four stop posts on the anti-torsion tray are pressed against the rock wall, so that the ribbed tray in coordination with the anti-torsion tray in terms of orientation and the hollow anti-torsion sleeve can be limited in the radial direction, thereby a situation that the ribbed tray and the flexible hollow rod body rotate in the pre-tightening process can be avoided, and the anchoring strength of the anchor rod can be significantly improved. The tapered section of the outer contour of the hole sealing sheath is used to plug the transition part between the large-diameter drill hole and the small-diameter drill hole, and the continuous fluctuation section of the outer contour of the hole sealing sheath is used to plug the large-diameter drill hole at the same time, thus, the clearance between the rod body and the hole can be plugged with multiple means, thereby the plugging effect is significantly improved. After the grouting is finished, the grout stop plug is mounted to the left end of the core tube mounting hole through nut fitting, thereby the core tube mounting hole can be effectively plugged, and overflow of the grout from the core tube mounting hole can be avoided.

Compared with the prior art, the flexible hollow anchor rod integrating digital monitoring and the construction method have the following advantages:
(1) The rod body is made of a high-strength steel strand, and it only needs to be pre-tightened by turning the nut during construction; thus, the anchor rod in the present invention can achieve high-strength extended anchorage more easily when compared with ordinary anchor rods; besides, the required installation time is shorter, thereby the excavated roadway can be supported timely, the roadway excavation efficiency can be greatly improved, and the combination with intelligent rapid excavation equipment can be promoted;
(2) The flexible hollow anchor rod integrates an anti-torsion device and a grouting hole sealing device on the rod body, thus integrated installation is realized, complicated operation procedures are avoided, the support time is shortened, and the grouting efficiency is greatly improved;
(3) A centering positioner is arranged on the end of the flexible hollow anchor rod body, thereby the anchoring agent can be stirred extensively, and the rod body is centered in the stirring process, thus the anchoring strength can be improved and a high-quality supporting system can be built up;
(4) The fiber grating sensors in the flexible hollow anchor rod are attached in the grooves of the steel strand, thereby reduction of the strength of the rod body as a result of grooving can be avoided without increasing the diameter of the current rod body, and the stress in the rod body can be monitored along the entire length with the three fiber grating sensors jointly arranged in a staggered manner, and a problem of missed detection in the traditional scheme using one fiber grating sensor can be avoided effectively;
(5) Compared with conventional butterfly trays, the ribbed tray in the flexible hollow anchor rod is lighter in weight and has higher bearing capacity, thereby the labor intensity of underground workers can be effectively reduced.

The present invention can realize high-strength extended anchorage, and it employs simple construction steps, and can effectively improve the excavation efficiency; efficient grouting operation can be realized with the integrated hole sealing device; with the fiber grating sensors, the support condition can be monitored in real time without reducing strength of the anchor rod, and the present invention is beneficial to build up a high-quality support system.

### BRIEF DESCRIPTION OF DRAWINGS

FIG. 1 is a schematic diagram of the flexible hollow anchor rod of the present invention under supporting state;

FIG. 2 is a schematic structural diagram of the stepped drill hole in the present invention;

FIG. 3 is a schematic structural diagram of the flexible hollow anchor rod in the present invention;

FIG. 4 is an assembly diagram of the hollow anti-torsion sleeve, the grout stop ring and the friction-increasing wire spring in the present invention;

FIG. 5 is a schematic perspective view of the hollow anti-torsion sleeve in the present invention;

FIG. 6 is a schematic structural diagram of the flexible hollow rod body in the present invention;

FIG. 7 is a schematic structural diagram of the centering positioner in the present invention;

FIG. 8 is a structural schematic diagram of the hole sealing sheath in the present invention;

FIG. 9 is a structural schematic diagram of the anti-torsion tray in the present invention;

FIG. 10 is a schematic structural diagram of a ribbed tray in the present invention;

FIG. 11 is a schematic structural diagram of the fiber grating sensor in the present invention;

FIG. 12 is a schematic assembly diagram of the anti-torsion tray, the hollow anti-torsion sleeve and the fiber grating sensor in the present invention;

FIG. 13 is a schematic assembly diagram of the fiber grating sensor and the steel strand in the present invention; and

FIG. 14 is a schematic assembly diagram of the fiber grating sensor and the flexible hollow rod body in the present invention.

In the figures: 1—flexible hollow rod body, 1.1—hollow anti-torsion sleeve, 1.1a—anti-torsion connecting section, 1.1b—annular transition boss, 1.1c—first external thread structure, 1.1d—internal thread structure, 1.1e—fastening section, 1.1f—strip-shaped through groove, 1.1g—rod body mounting cavity, 1.1h—core tube mounting hole, 1.2—steel strand, 1.2a—grout outlet, 1.2b—pin, 1.2c—hollow steel tube, 1.2d—grout passage, 1.3—friction-increasing wire spring, 1.4—grout stop ring, 1.5—grout stop plug, 1.6—centering positioner; 1.6a—positioning sleeve, 1.6b—positioning clip; 2—hole sealing sheath, 2.1—drum-shaped section structure, 2.2—tapered structure; 3—anti-torsion tray, 3.1—central tray body, 3.1a—positioning bump, 3.1b—anti-torsion mounting hole, 3.1c—positioning notch, 3.2—stop post; 4—ribbed tray, 4.1—raised longitudinal rib, 4.2—octagonal groove, 4.3—small through hole, 4.4—ball head positioning hole, 4.5—bearing part, 4.6—supporting part, 4.7—main body part; 5—self-aligning ball head; 6—anti-wear gasket; 7—torque nut; 8—fiber grating sensor, 8.1—optical fiber, 8.2—optical grating; 9—stepped drill hole, 9.1—large-diameter section of holes, 9.2—small-diameter section of holes; 10—rock mass.

### EMBODIMENTS

The present invention will be further detailed below.

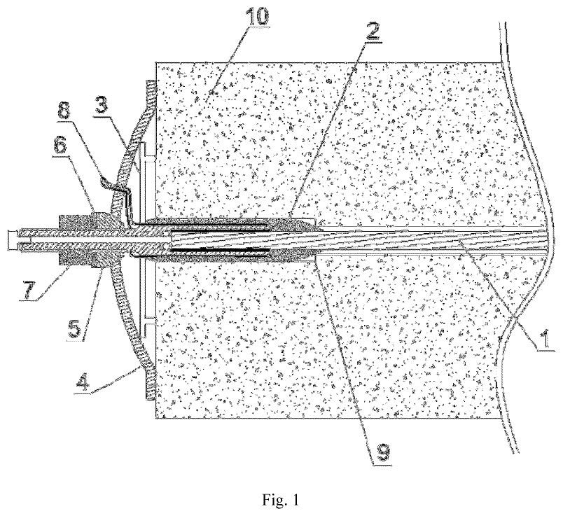

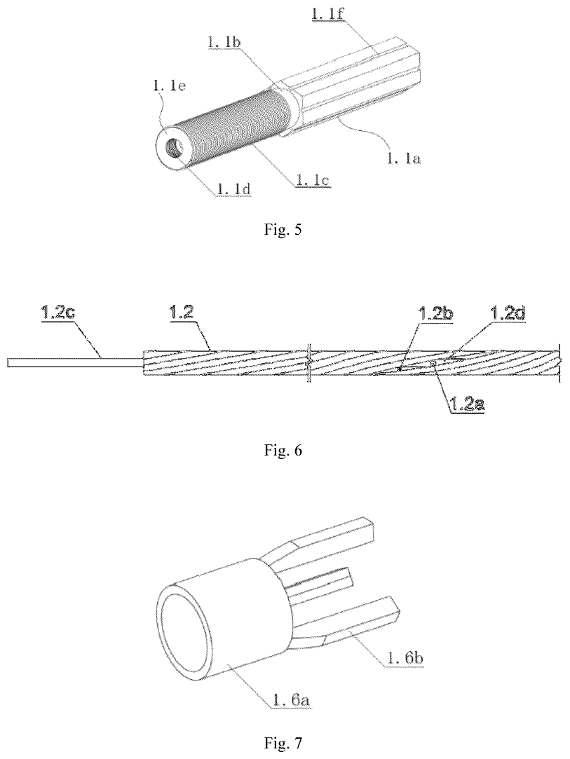

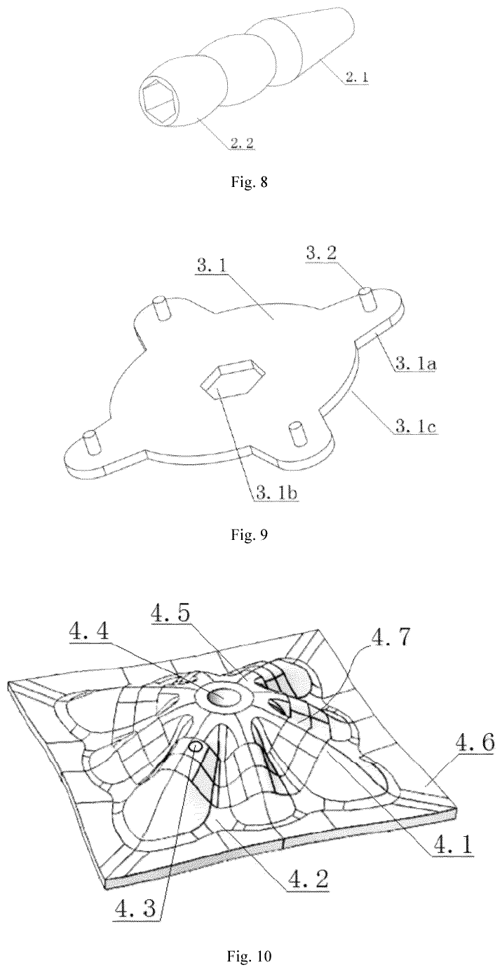

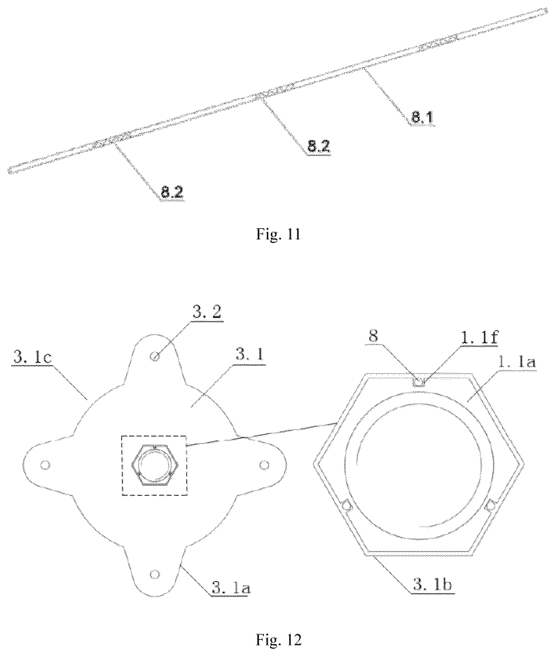

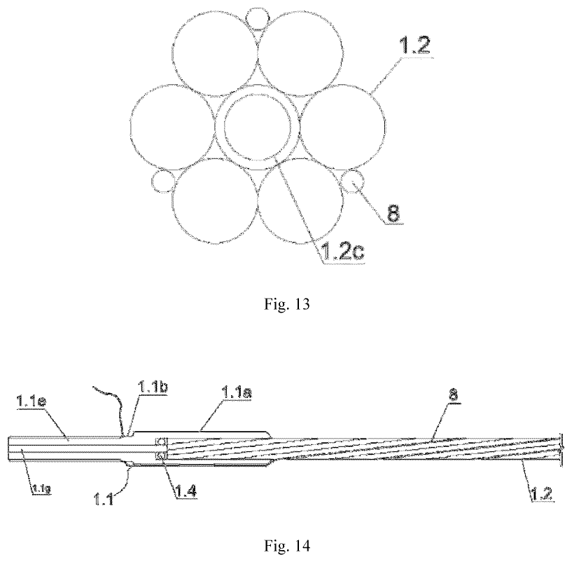

As shown in FIGS. 1-14, the present invention provides a flexible hollow anchor rod integrating digital monitoring, which comprises a flexible hollow rod body 1, a hole sealing sheath 2, an anti-torsion tray 3, a ribbed tray 4, a self-aligning ball head 5, an anti-wear gasket 6, a torque nut 7 and a fiber grating sensor 8;
the flexible hollow rod body 1 consists of a hollow anti-torsion sleeve 1.1, a grout stop ring 1.4, a friction-increasing wire spring 1.3, a steel strand 1.2, a hollow steel tube 1.2c, a grout stop plug 1.5 and a centering positioner 1.6;
the left half part of the hollow anti-torsion sleeve 1.1 is a fastening section 1.1e, the right half part of the hollow anti-torsion sleeve is an anti-torsion connecting section 1.1a, the cross section of the outer contour of the anti-torsion connecting section 1.1a is a regular polygon structure, a strip-shaped through groove 1.1f is formed in each surface of the outer contour of the anti-torsion connecting section, a rod body mounting cavity 1.1g is formed at the axis of the anti-torsion connecting section 1.1a; the outer contour of the fastening section 1.1e is a cylindrical structure, a first external thread structure 1.1c is formed on the outer contour of the fastening section, a core tube mounting hole 1.1h is formed at the axis of the fastening section 1.1e, and a section of internal thread structure 1.1d is formed inside a left end of the core tube mounting hole 1.1h; a right end of the core tube mounting hole 1.1h is in communication with a left end of the rod body mounting cavity 1.1g;
the outer diameter of the grout stop ring 1.4 matches the inner diameter of the rod body mounting cavity 1.1g, and the grout stop ring is coaxially assembled in the left end of the rod body mounting cavity 1.1g;
the outer diameter of the friction-increasing wire spring 1.3 matches the inner diameter of the rod body mounting cavity 1.1g, and the friction-increasing wire spring is coaxially assembled in the rod body mounting cavity 1.1g and located at the right side of the grout stop ring 1.4;
the steel strand 1.2 is formed from a plurality of steel wires spirally wound together, with a central cavity formed at the axis; a pin 1.2b is radially inserted into a middle section of the steel strand 1.2, and a grout passage 1.2d for communicating the central cavity with the external space is reserved by means of the inserted pin 1.2b;
the left section of the hollow steel tube 1.2c is a main body mounting section, and a section of the hollow steel tube on the right of the main body mounting section is a rod body mounting section; the rod body mounting section of the hollow steel tube 1.2c is fixedly inserted into the central cavity of the steel strand 1.2, and has a grout outlet 1.2a arranged at a position corresponding to the grout passage 1.2d; the hollow steel tube 1.2c and the steel strand 1.2 jointly form the flexible hollow rod body after they are connected together;
the left part of the formed flexible hollow rod body is inserted into the rod body mounting cavity 1.1g inside the hollow anti-torsion sleeve 1.1, the left end of the steel strand 1.2 is inserted into a spring cavity of the friction-increasing wire spring 1.3, and is fixedly connected with the anti-torsion connecting section 1.1a through mutual squeezing action with the friction-increasing wire spring 1.3; besides, the main body mounting section of the hollow steel tube 1.2c is fixedly inserted into the core tube mounting hole 1.1h after passing through the grout stop ring 1.4, and the left end of the main body mounting section is stopped at the right side of the right end of the internal thread structure 1.1d;
the external surface of the plug body of the grout stop plug 1.5 is provided with a second external thread structure, and the grout stop plug is assembled at the left end of the core tube mounting hole 1.1h through thread-fitting between the second external thread structure and the internal thread structure 1.1d;
the centering positioner 1.6 consists of a positioning sleeve 1.6a and three positioning clips 1.6b, the three positioning clips 1.6b are evenly distributed in an annular shape, the left ends thereof are evenly fixedly connected to the edge of the right end of the positioning sleeve 1.6a in a circular manner, and the centering positioner 1.6 is fixedly fitted around the outside of the right end of the steel strand 1.2 via the positioning sleeve 1.6a;
the hole sealing sheath 2 is made of an elastic sealing material, and consists of a continuous fluctuation section 2.2 on the left and a tapered section 2.1 on the right, and the hole sealing sheath 2 is sleeved outside a transition area where the hollow anti-torsion sleeve 1.1 is connected with the flexible hollow rod body, wherein the outer contour of the continuous fluctuation section 2.2 is a continuous fluctuation type changing structure, and the continuous fluctuation section is sleeved outside the anti-torsion connecting section 1.1a, the outer contour of the tapered section 2.1 is a tapered structure whose outer diameter is reduced gradually from left to right, and the tapered section is sleeved outside the steel strand 1.2; preferably, the length of the continuous fluctuation section 2.2 is slightly smaller than the length of the anti-torsion connecting section 1.1a, so that a space for assembling the anti-torsion tray 3 can be provided.
the anti-torsion tray 3 consists of a central tray body 3.1 and four stop posts 3.2, the tray body 3.1 is a flat plate structure, a regular polygonal anti-torsion mounting hole 3.1b that matches the outer contour shape of the anti-torsion connecting section 1.1a is formed at the center of the tray body, four positioning notches 3.1c are evenly arranged in circumferential on an outer edge surface of the tray body, and four positioning bumps 3.1a are formed between the four positioning notches 3.1c; the four stop posts 3.2 are evenly distributed in circumferential around the anti-torsion mounting hole 3.1b and arranged in one-to-one correspondence with the four positioning bumps 3.1a, and each stop post 3.2 is vertically and fixedly connected to a corresponding positioning bump 3.1a; the anti-torsion tray 3 is sleeved outside the left end of the anti-torsion connecting section 1.1a through the anti-torsion mounting hole 3.1b, and the four stop posts 3.2 are located on the right side of the central tray body 3.1;
the ribbed tray 4 consists of a main body part 4.7 located in the central area and a supporting part 4.6 located on the periphery of the main body part 4.7, the main body part 4.7 protrudes gradually from the periphery to the center in a direction away from the supporting part 4.6, and forms eight raised longitudinal ribs 4.1 evenly in the circumferential direction; besides, a bearing part 4.5 parallel to the supporting part 4.6 is formed in the central area of the eight raised longitudinal ribs 4.1, eight octagonal grooves 4.2 are evenly formed on inner edges of the eight raised longitudinal ribs 4.1, and the size of a space formed inside the eight raised longitudinal ribs 4.1 matches the size of the central tray body 3.1; a small through hole 4.3 is formed in a side of the main body part 4.7; a ball head positioning hole 4.4 is formed at the center of the bearing part 4.5, and the center of the ball head positioning hole 4.4 is recessed in a ball socket form in a direction getting close to the supporting part 4.6; the ribbed tray 4 is fitted around the outside of the fastening section 1.1e through the ball head positioning hole 4.4, and four non-adjacent octagonal grooves 4.2 in the inner surface of the ribbed tray 4 are positioned and fitted with the four bumps 3.1a on the anti-torsion tray 3;
the self-aligning ball head 5 is a hemispherical structure, with an anchor hole formed at the axis, the self-aligning ball head 5 is fitted around the fastening section 1.1e through the anchor hole, and a spherical part of the self-aligning ball head is inserted into the ball head positioning hole 4.4;
the anti-wear gasket 6 is fitted around the outside of the fastening section 1.1e and is snugly connected with a planar part of the self-aligning ball head 5;
the torque nut 7 is assembled outside the fastening section 1.1e through thread-fitting between the internal thread structure of the torque nut and the first external thread structure 1.1c, and sequentially presses the anti-wear gasket 6, the self-aligning ball head 5 and the ribbed tray 4 located on the right side thereof toward the anti-torsion tray 3; preferably, the anchoring length of the flexible hollow anchor rod is 1,800-11,000 mm, i.e., the length of the rock mass clamped between the supporting part 4.6 of the ribbed tray 4 and the centering positioner 1.6 is 1,800-11,000 mm after compression, thus, it can be ensured that the flexible hollow anchor rod has a great anchoring length;
the fiber grating sensor 8 consists of an optical fiber 8.1 and a plurality of optical gratings 8.2 arranged on the optical fiber 8.1; three fiber grating sensors 8 are evenly arranged in circumferential, and each fiber grating sensor 8 is embedded and bonded in a spiral mounting groove formed between two adjacent steel wires, the right end of the fiber grating sensor extends to the left end of the centering positioner 1.6, and the left end of the fiber grating sensor is terminated at the right end of the hollow anti-torsion sleeve 1.1; three fiber output sections correspondingly connected to the three fiber grating sensors 8 pass through three strip-shaped through grooves 1.1f and then enter into the inner cavity of the ribbed tray 4, and are led out of the ribbed tray 4 through the small through holes 4.3.

Preferably, the outer contour of the anti-torsion connecting section 1.1a has a regular hexagon shape, and six strip-shaped through grooves 1.1f are evenly arranged on the outer contour of the anti-torsion connecting section 1.1a in the circumferential direction, wherein the three fiber output sections correspondingly connected to the three fiber grating sensors 8 are arranged in the three strip-shaped through grooves 1.1f in a manner that every two of them are not adjacent to each other.

Preferably, the outer diameter of the fastening section 1.1e is smaller than the outer diameter of the anti-torsion connecting section 1.1a, the hollow anti-torsion sleeve 1.1 is provided with an annular transition boss 1.1b between the fastening section 1.1e and the anti-torsion connecting 1.1a, and the outer diameter of the annular transition boss 1.1b is greater than the outer diameter of the fastening section 1.1e and smaller than the outer diameter of the anti-torsion connecting section 1.1a.

Preferably, the cross section of the bore of the continuous fluctuation section 2.2 has a regular polygon shape that matches the outer contour of the anti-torsion connecting section 1.1a, and the outer contour of the continuous fluctuation section is a multi-sectioned continuously-arranged drum structure, and the cross section of the bore of the tapered section 2.1 has a circular shape that matches the outer contour of the steel strand.

Preferably, the stop posts 3.2 are fixedly connected to the positioning bumps 3.1a by means of bonding or welding.

Furthermore, in order to conveniently check the stress state of each part of the anchoring section in real time, the flexible hollow anchor rod further comprises a fiber grating demodulator, which is connected to the fiber output sections of the three fiber grating sensors 8 respectively.

In order to ensure the service life of the anti-wear gasket, the anti-wear gasket 6 is made of polytetrafluoroethylene (PTFE) material.

In order to effectively hold the anchoring agent and significantly improve the stirring effect, the size of an annular space enclosed by the three positioning clips 1.6b is consistent with the inner diameter of the positioning sleeve 1.6a, and the dimension of the outer edges of the three positioning clips 1.6b are greater than the outer diameter of the positioning sleeve 1.6a.

In order to improve the sealing effect and ensure the good service life of the hole sealing sheath, the hole sealing sheath 2 is made of rubber material.

In the present invention, a core tube mounting hole and a rod body mounting cavity that are in communication with each other are arranged at the axis of the hollow anti-torsion sleeve, so that when the left end of the steel strand is inserted into the rod body mounting cavity, an exposed main body mounting section of the hollow steel tube can be inserted into the core tube mounting hole, thereby a grouting function can be realized by using the core tube mounting hole in coordination with the main body mounting section of the hollow steel tube. A friction-increasing wire spring is arranged between the steel strand and the hollow anti-torsion sleeve, and the friction-increasing wire spring can be used to significantly improve the friction force, so as to ensure that the steel strand can be firmly connected to the inside of the anti-torsion sleeve by buckling, and the bearing capacity of the connection can be effectively ensured. A grout stop ring is fitted at the left end of the rod body mounting cavity, and the root of the main body mounting section of the hollow steel tube is inserted into the grout stop ring, so that the gap between the outer round surface of the hollow steel tube and the inner round surface of the rod body mounting cavity can be plugged by the grout stop ring, thereby the grout injected into the steel strand can be effectively prevented from overflowing from the gap between the core tube mounting hole and the hollow steel tube. By inserting a pin in the middle section of the steel strand radially, a grout passage can be reserved among the plurality of steel wires by means of the pin, and the grout passage can be effectively prevented from being buried by the steel wires; due to the hollow steel tube having a grout outlet inside the steel strand, it ensures that the grout entering the central cavity can smoothly flow out of the steel strand through the grout passage, thereby the gap between the steel strand and the wall of the drill hole can be effectively filled with the grout; thus, the flexible hollow rod body can be firmly fixed in the drill hole after the grout solidifies. A centering positioner is assembled in the tail end of the steel strand, and three positioning clips are evenly arranged on the right end of the centering positioner; thus, the anchoring agent can be positioned and pulled conveniently, and can be stirred extensively in the rotation process by means of the positioning clips; moreover, the flexible hollow rod body can be positioned in the central area of the drill hole in the stirring process, thereby the injected grout can be uniformly filled in the gap between the rod body and the drill hole, the anchoring force can be significantly improved, and a high-quality support system can be built up. The outer contour of the anti-torsion connecting section of the right half part of the hollow anti-torsion sleeve has a regular polygon shape, and the anti-torsion mounting hole at the center of the anti-torsion tray has a regular polygon shape that matches the shape of the anti-torsion connecting section; thus, when the anti-torsion tray is fitted around the outside of the anti-torsion connecting section on the hollow anti-torsion sleeve, no relative rotation between the anti-torsion tray and the hollow anti-torsion sleeve will occur. Since four stop posts are vertically and fixedly connected around one side of the anti-torsion tray, in the actual installation process, rotation of the flexible hollow rod body in the pre-tightening process can be effectively avoided simply by using the locking force provided by the torque nut to press the four stop posts on the anti-torsion tray against the surface of the rock wall, thereby greater pre-tightening force can be applied, and the supporting effect is greatly improved. The fastening section on the left half part of the hollow anti-torsion sleeve is a cylindrical structure, and is provided with a first external thread structure; thus, the ribbed tray, the self-aligning ball head and the torque nut can be conveniently fitted on the fastening section, and a pre-tightening force can be easily exerted by means of the torque nut through thread-fitting; a strip-shaped through groove is formed on each surface of the outer contour of the anti-torsion connecting section; thus, the optical fiber output section of the fiber grating sensor arranged on the surface of the steel strand can be embedded in the strip-shaped through groove, and damages to the optical fiber resulted from foreign objects rubbing the optical fiber can be effectively avoided. A section of internal thread structure is arranged in the core tube mounting hole at the end of the fastening section, and the surface of the plug body of the grout stop plug is provided with a second external thread structure, so that the grout stop plug can be stably assembled to the end of the core tube mounting hole through thread-fitting, thereby the grouting passage can be effectively plugged, so that a situation of grout overflow after grouting is avoided. By wrapping the hole sealing sheath around the outside the joint between the steel strand and the hollow anti-torsion sleeve, the grout will not overflow from the joint during grouting, and the gap between the anchor rod and the drill hole can be effectively plugged by means of the outer contour of the hole sealing sheath which is expanded under a squeezing action, thereby the grout will not overflow from the gap between the drill hole and the anchor rod, and an integrated overall hole sealing operation can be realized; the right end of the continuous fluctuation section is configured as a tapered section, which is beneficial for effectively plugging the diameter-varied transition part of the drill hole in the installation process. Eight raised longitudinal ribs are evenly arranged on the outer surface of the main body of the ribbed tray in the circumferential direction, so that the bearing capacity of the ribbed tray can be effectively improved and a higher pre-tightening force can be advantageously applied to the anchor rod; besides, since such a tray with the raised longitudinal rib structures can provide greater bearing capacity, a lighter ribbed tray can be used to replace the traditional butterfly tray under the same support requirements, so as to reduce the labor load of the underground workers; eight octagonal grooves are evenly arranged on the inner surface of the ribbed tray in the circumferential direction, so that four of the octagonal grooves can be conveniently used for positioning and fitting with four positioning bumps on the periphery of the anti-torsion tray; thus, when the four stop posts on the anti-torsion tray are pressed against the rock wall, the rotation can be avoided in the process of applying the pre-tightening force by cooperating with the anti-torsion tray. The main body is provided with a small through hole, so that the output ends of the fiber grating sensors can penetrate into the external space for connection with a fiber grating demodulator. The self-aligning ball head is configured as a hemispherical structure, and a socket-shaped ball head positioning hole is formed at the center of the ribbed tray, so that the spherical part of the self-aligning ball head is always in annular linear contact with the ball head positioning hole of the ribbed tray during the process of applying the pre-tightening force, thereby the purpose of automatic self-aligning is attained, the ribbed tray will not deviate from the predetermined mounting position in the process of applying the pre-tightening force; thus, the construction quality can be improved, and the supporting effect can be ensured. The anti-wear gasket arranged between the torque nut and the planar part of the self-aligning ball head is beneficial to protection of the torque nut and the self-aligning ball head in the process of applying the pre-tightening force, and a situation that the supporting strength is compromised owing to mutual damage can be avoided. Since the fiber grating sensors are arranged in the spiral mounting grooves formed between adjacent steel wires on the outer surface of the steel strand, the stress in the effective anchoring rod body can be monitored along the entire length, so as to ascertain the stress condition of the effective anchoring rod body in real time; moreover, a situation that the strength of the rod body is reduced as a result of direct grooving in the surface of the rod body can be avoided, without increasing the diameter of the rod body, thus the anchoring force of the rod body is effectively ensured. In addition, since three fiber grating sensors are evenly distributed on the surface of the steel strand, a situation of missed detection, which may easily occur in the traditional scheme using only one fiber grating sensor, can be avoided effectively.

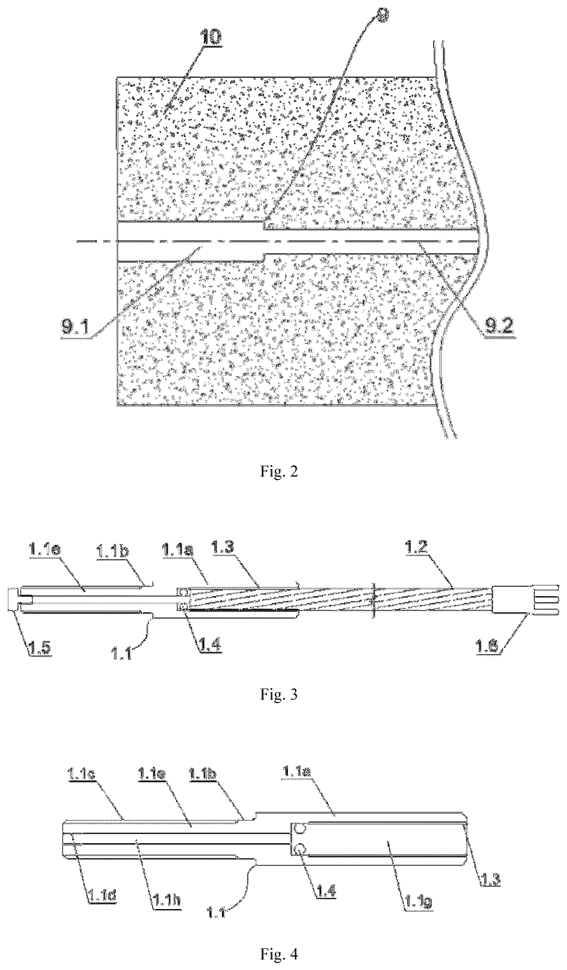

The present invention further provides an installation method of the flexible hollow anchor rod integrating digital monitoring, which uses a flexible hollow anchor rod integrating digital monitoring and comprises the following steps:
step 1: as shown in FIG. 2, drilling a stepped drill hole 9 in a rock mass 10, wherein the stepped drill hole 9 consists of a large-diameter section of drill holes 9.1 proximal to the surface of the rock mass 10 and a small-diameter section of drill holes 9.2 distal to the surface of the rock mass 10, the pore diameter and length of the large-diameter section of drill holes 9.1 match the pore diameter and length of the hole sealing sheath 2, and the pore diameter and length of the small-diameter section of drill holes 9.2 match the pore diameter and length of the steel strand 1.2;
step 2: as shown in FIG. 14, first, arranging the three fiber grating sensors 8 whose length match the length of the steel strand 1.2 evenly on the outer surface of the steel strand 1.2 in the circumferential direction, and bonding each fiber grating sensor 8 in the spiral mounting groove formed between every two adjacent steel wires, and embedding the three fiber output sections correspondingly connected to the three fiber grating sensors 8 in the three strip-shaped through grooves 1.1f on the hollow anti-torsion sleeve 1.1 at the same time; then, sleeving the hole sealing sheath 2 outside the hollow anti-torsion sleeve 1.1; next, fitting the anti-torsion tray 3 around the left end of the hollow anti-torsion sleeve 1.1, so that the stop posts 3.2 are located at a side close to the hole sealing sheath 2; finally, fitting the ribbed tray 4, the self-aligning ball head 5, the anti-wear gasket 6 and the torque nut 7 around the fastening section 1.1e sequentially, so that the self-aligning ball head 5 is embedded in the ball head positioning hole 4.4;
step 3: first, placing an anchoring agent in the stepped drill hole 9, then using the centering positioner 1.6 fixed at the end of the flexible hollow rod body 1 to press the anchoring agent and push the anchoring agent to the bottom of the stepped drill hole 9; next, starting an anchor rod drill to drive the torque nut 7 to rotate and synchronously drive the flexible hollow rod body 1 to rotate, and then using the three positioning clips 1.6b on the centering positioner 1.6 to stir the anchoring agent; driving the anchor rod drill to move further toward the bottom of the hole to evenly stir the anchoring agent while the flexible hollow rod body 1 rotates; waiting for 30 seconds after the anchor rod drill is driven to the bottom of the hole, so that the anchoring agent fully solidifies;
step 4: switching on the anchor rod drill again to destroy a pin piece on the torque nut 7 to make the torque nut 7 rotate toward the bottom of the hole along the first external thread structure 1.1c on the fastening section 1.1e and press against the anti-wear gasket 6 and the self-aligning ball head 5, thereby driving the ribbed tray 4 and the anti-torsion tray 3 to move in the axial direction of the fastening section 1.1e toward the bottom of the hole, so that the four stop posts 3.2 on the anti-torsion tray 3 are pressed against the rock wall, using the anti-torsion tray 3 to drive the hole sealing sheath 2 to move toward the bottom of the hole, and pushing the tapered section 2.1 of the outer contour of the hole sealing sheath 2 into the joint between the large-diameter drill hole 9.1 and the small-diameter drill hole 9.2; in this process, positioning the hollow anti-torsion sleeve 1.1 and the ribbed tray 4 in the rotation direction by using the positioned anti-torsion tray 3, plugging the transition between the large-diameter drill hole 9.1 and the small-diameter drill hole 9.2 with the tapered section 2.1 of the outer contour of the hole sealing sheath 2, and, at the same time, sealing the large-diameter drill hole 9.1 with the continuous fluctuation section 2.2 of the outer contour of the hole sealing sheath 2 that has expanded in volume owing to a squeezing action;
step 5: withdrawing the anchor rod drill, then repeating the steps 1-4 to perform the installation operation of the flexible hollow anchor rod sequentially;
step 6: for each flexible hollow anchor rod, removing the grout stop plug 1.5 from the hollow anti-torsion sleeve 1.1, mounting a grouting pipe at the core tube mounting hole 1.1h at the axis of the fastening section 1.1e , and grouting through the grouting pipe; wherein grouting is not carried out immediately after the installation of the flexible hollow anchor rod, because the factures in the surrounding rock of the roadway has not fully developed at this time;
instead, grouting is carried out after the stress of the roadway is completely relieved and a new balance is achieved, at this time the fractures has developed to a certain degree but are not in communication with each other yet and the stability of the surrounding rock can be maintained; by controlling the grouting time accurately and utilizing a delayed grouting operation, the injected grout can flow through the core tube mounting hole 1.1h, the hollow steel tube 1.2c and the grout outlet 1.2a on the hollow steel tube 1.2c and enters the central cavity of the steel strand 1.2, and then the injected grout is filled through the grout passage 1.2d on the steel strand 1.2 into the space between the steel strand 1.2 and the small-diameter section of drill holes 9.2; after the grouting, mounting the grout stop plug 1.5 to the left end of the core tube mounting hole 1.1h through thread-fitting to reset the grout stop plug 1.5, so as to effectively block the grout and close the fractures in the rock mass;
step 7: connecting the three fiber output sections correspondingly connected to the three fiber grating sensors 8 on each flexible hollow anchor rod to a fiber grating demodulator, so as to monitor the stress in each flexible hollow anchor rod with the fiber grating demodulator.

In the present invention, a stepped drill hole is drilled in the rock mass, so that a small-diameter section of drill holes can be used for accommodating the flexible hollow rod body, while a large-diameter section of drill holes can be used for accommodating the hollow anti-torsion sleeve sleeved with the hole sealing sheath; three fiber grating sensors are evenly arranged on the surface of the steel strand, and each fiber grating sensor is bonded in a spiral mounting groove formed between every two adjacent steel wires, so that the anchor rod can be provided with a stress monitoring function, thereby stress monitoring for the rod body along the entire length can be realized, without increasing the outer diameter of the rod body or damaging the structure of the rod body. After the anchoring agent is loaded into the drill hole, the anchoring agent can be stirred extensively with the three positioning clips on the central locator, so that the anchoring effect can be significantly improved. In the process of applying pre-tightening force, the self-aligning ball head is used to push the ribbed tray to move toward the bottom of the hole, so as to achieve the purpose of automatic self-aligning, thereby the ribbed tray will not deviate from the predetermined mounting position during application of the pre-tightening force, and the construction quality can be improved. The four stop posts on the anti-torsion tray are pressed against the rock wall, so that the ribbed tray in coordination with the anti-torsion tray in terms of orientation and the hollow anti-torsion sleeve can be limited in the radial direction, thereby a situation that the ribbed tray and the flexible hollow rod body rotate in the pre-tightening process can be avoided, and the anchoring strength of the anchor rod can be significantly improved. The tapered section of the outer contour of the hole sealing sheath is used to plug the transition part between the large-diameter drill hole and the small-diameter drill hole, and the continuous fluctuation section of the outer contour of the hole sealing sheath is used to plug the large-diameter drill hole at the same time, thus, the clearance between the rod body and the hole can be plugged with multiple means, thereby the plugging effect is significantly improved. After the grouting is finished, the grout stop plug is mounted to the left end of the core tube mounting hole through nut fitting, thereby the core tube mounting hole can be effectively plugged, and overflow of the grout from the core tube mounting hole can be avoided.

Compared with the prior art, the flexible hollow anchor rod integrating digital monitoring and the construction method have the following advantages:
(1) The rod body is made of a high-strength steel strand, and it only needs to be pre-tightened by turning the nut during construction; thus, the anchor rod in the present invention can achieve high-strength extended anchorage more easily when compared with ordinary anchor rods; besides, the required installation time is shorter, thereby the excavated roadway can be supported timely, the roadway excavation efficiency can be greatly improved, and the combination with intelligent rapid excavation equipment can be promoted;
(2) The flexible hollow anchor rod integrates an anti-torsion device and a grouting hole sealing device on the rod body, thus integrated installation is realized, complicated operation procedures are avoided, the support time is shortened, and the grouting efficiency is greatly improved;
(3) A centering positioner is arranged on the end of the flexible hollow anchor rod body, thereby the anchoring agent can be stirred extensively, and the rod body is centered in the stirring process, thus the anchoring strength can be improved and a high-quality supporting system can be built up;
(4) The fiber grating sensors in the flexible hollow anchor rod are attached in the grooves of the steel strand, thereby reduction of the strength of the rod body as a result of grooving can be avoided without increasing the diameter of the current rod body, and the stress in the rod body can be monitored along the entire length with the three fiber grating sensors jointly arranged in a staggered manner, and a problem of missed detection in the traditional scheme using one fiber grating sensor can be avoided effectively;
(5) Compared with conventional butterfly trays, the ribbed tray in the flexible hollow anchor rod is lighter in weight and has higher bearing capacity, thereby the labor intensity of underground workers can be effectively reduced.

The present invention can realize high-strength extended anchorage, and it employs simple construction steps, and can effectively improve the excavation efficiency; efficient grouting operation can be realized with the integrated hole sealing device; with the fiber grating sensors, the support condition can be monitored in real time without reducing strength of the anchor rod, and the present invention is beneficial to build up a high-quality support system.

1. : A flexible hollow anchor rod integrating digital monitoring, comprising a flexible hollow rod body, wherein, said flexible hollow anchor rod further comprises a hole sealing sheath, an anti-torsion tray, a ribbed tray, a self-aligning ball head, an anti-wear gasket, a torque nut and a fiber grating sensor;
wherein the flexible hollow rod body comprises of a hollow anti-torsion sleeve, a grout stop ring, a friction-increasing wire spring, a steel strand, a hollow steel tube, a grout stop plug and a centering positioner;
wherein the left half part of the hollow anti-torsion sleeve is a fastening section, the right half part of the hollow anti-torsion sleeve is an anti-torsion connecting section, the cross section of the outer contour of the anti-torsion connecting section is a regular polygon structure, a strip-shaped through groove is formed in each surface of the outer contour of the anti-torsion connecting section, a rod body mounting cavity is formed at the axis of the anti-torsion connecting section; the outer contour of the fastening section is a cylindrical structure, a first external thread structure is formed on the outer contour of the fastening section, a core tube mounting hole is formed at the axis of the fastening section, and a section of internal thread structure is formed inside a left end of the core tube mounting hole;
a right end of the core tube mounting hole is in communication with a left end of the rod body mounting cavity;
wherein the outer diameter of the grout stop ring matches the inner diameter of the rod body mounting cavity, and the grout stop ring is coaxially assembled in the left end of the rod body mounting cavity;
wherein the outer diameter of the friction-increasing wire spring matches the inner diameter of the rod body mounting cavity, and the friction-increasing wire spring is coaxially assembled in the rod body mounting cavity and located at the right side of the grout stop ring;
wherein the steel strand is formed from a plurality of steel wires spirally wound together, with a central cavity formed at the axis; a pin is radially inserted into a middle section of the steel strand, and a grout passage for communicating the central cavity with the external space is reserved by the inserted pin;
wherein the left section of the hollow steel tube is a main body mounting section, and a section of the hollow steel tube on the right of the main body mounting section is a rod body mounting section; the rod body mounting section of the hollow steel tube is fixedly inserted into the central cavity of the steel strand, and has a grout outlet arranged at a position corresponding to the grout passage; the hollow steel tube and the steel strand jointly form the flexible hollow rod body after they are connected together;
wherein the left part of the formed flexible hollow rod body is inserted into the rod body mounting cavity inside the hollow anti-torsion sleeve, the left end of the steel strand is inserted into a spring cavity of the friction-increasing wire spring, and is fixedly connected with the anti-torsion connecting section through mutual squeezing action with the friction-increasing wire spring; besides, the main body mounting section of the hollow steel tube is fixedly inserted into the core tube mounting hole after passing through the grout stop ring, and the left end of the main body mounting section is stopped at the right side of the right end of the internal thread structure;
wherein the external surface of the plug body of the grout stop plug is provided with a second external thread structure, and the grout stop plug is assembled at the left end of the core tube mounting hole through thread-fitting between the second external thread structure and the internal thread structure;
wherein the centering positioner comprises a positioning sleeve and three positioning clips, the three positioning clips are evenly distributed in an annular shape, the left ends thereof are evenly fixedly connected to the edge of the right end of the positioning sleeve in a circular manner, and the centering positioner is fixedly fitted around the outside of the right end of the steel strand via the positioning sleeve;
wherein the hole sealing sheath is made of an elastic sealing material, and comprises a continuous fluctuation section on the left and a tapered section on the right, and the hole sealing sheath is sleeved outside a transition area where the hollow anti-torsion sleeve is connected with the flexible hollow rod body, wherein the outer contour of the continuous fluctuation section is a continuous fluctuation type changing structure, and the continuous fluctuation section is sleeved outside the anti-torsion connecting section, the outer contour of the tapered section is a tapered structure whose outer diameter is reduced gradually from left to right, and the tapered section is sleeved outside the steel strand;
wherein the anti-torsion tray comprises a central tray body and four stop posts, the tray body is a flat plate structure, a regular polygonal anti-torsion mounting hole that matches the outer contour shape of the anti-torsion connecting section is formed at the center of the tray body, four positioning notches are evenly arranged in circumferential on an outer edge surface of the tray body, and four positioning bumps are formed between the four positioning notches;
the four stop posts are evenly distributed in circumferential around the anti-torsion mounting hole and arranged in one-to-one correspondence with the four positioning bumps, and each stop post is vertically and fixedly connected to a corresponding positioning bump; the anti-torsion tray is sleeved outside the left end of the anti-torsion connecting section through the anti-torsion mounting hole, and the four stop posts are located on the right side of the central tray body;
wherein the ribbed tray comprises a main body part located in the central area and a supporting part located on the periphery of the main body part, the main body part protrudes gradually from the periphery to the center in a direction away from the supporting part, and forms eight raised longitudinal ribs evenly in the circumferential direction; besides, a bearing part parallel to the supporting part is formed in the central area of the eight raised longitudinal ribs, eight octagonal grooves are evenly formed on inner edges of the eight raised longitudinal ribs, and the size of a space formed inside the eight raised longitudinal ribs matches the size of the central tray body; a small through hole is formed in a side of the main body part; a ball head positioning hole is formed at the center of the bearing part, and the center of the ball head positioning hole is recessed in a ball socket form in a direction getting close to the supporting part; the ribbed tray is fitted around the outside of the fastening section through the ball head positioning hole, and four non-adjacent octagonal grooves in the inner surface of the ribbed tray are positioned and fitted with the four bumps on the anti-torsion tray;
wherein the self-aligning ball head is a hemispherical structure, with an anchor hole formed at the axis, the self-aligning ball head is fitted around the fastening section through the anchor hole, and a spherical part of the self-aligning ball head is inserted into the ball head positioning hole;
wherein the anti-wear gasket is fitted around the outside of the fastening section and is snugly connected with a planar part of the self-aligning ball head;
wherein the torque nut is assembled outside the fastening section through thread-fitting between the internal thread structure of the torque nut and the first external thread structure, and sequentially presses the anti-wear gasket, the self-aligning ball head and the ribbed tray located on the right side thereof toward the anti-torsion tray; and
the fiber grating sensor comprising an optical fiber and a plurality of optical gratings arranged on the optical fiber; three fiber grating sensors are evenly arranged in circumferential, and each fiber grating sensor is embedded and bonded in a spiral mounting groove formed between two adjacent steel wires, the right end of the fiber grating sensor extends to the left end of the centering positioner, and the left end of the fiber grating sensor is terminated at the right end of the hollow anti-torsion sleeve; three fiber output sections correspondingly connected to the three fiber grating sensors pass through three strip-shaped through grooves and then enter into the inner cavity of the ribbed tray, and are led out of the ribbed tray through the small through holes.

2. The flexible hollow anchor rod integrating digital monitoring according to claim 1, wherein the outer contour of the anti-torsion connecting section has a regular hexagon shape, and six strip-shaped through grooves are evenly arranged on the outer contour of the anti-torsion connecting section in the circumferential direction, wherein the three fiber output sections correspondingly connected to the three fiber grating sensors are arranged in the three strip-shaped through grooves in a manner that every two of them are not adjacent to each other.

3. The flexible hollow anchor rod integrating digital monitoring according to claim 2, wherein the outer diameter of the fastening section is smaller than the outer diameter of the anti-torsion connecting section, the hollow anti-torsion sleeve is provided with an annular transition boss between the fastening section and the anti-torsion connecting section, and the outer diameter of the annular transition boss is greater than the outer diameter of the fastening section and smaller than the outer diameter of the anti-torsion connecting section.

4. The flexible hollow anchor rod integrating digital monitoring according to claim 3, wherein the cross section of the bore of the continuous fluctuation section has a regular polygon shape that matches the outer contour of the anti-torsion connecting section, and the outer contour of the continuous fluctuation section is a multi-sectioned continuously-arranged drum, and the cross section of the bore of the tapered section has a circular shape that matches the outer contour of the steel strand.

5. The flexible hollow anchor rod integrating digital monitoring according to claim 4, wherein the stop posts are fixedly connected to the positioning bumps by bonding or welding.

6. The flexible hollow anchor rod integrating digital monitoring according to claim 5, further comprising a fiber grating demodulator, which is connected to the fiber output sections of the three fiber grating sensors respectively.

7. The flexible hollow anchor rod integrating digital monitoring according to claim 6, wherein the anti-wear gasket is made of polytetrafluoroethylene (PTFE) material.

8. The flexible hollow anchor rod integrating digital monitoring according to claim 7, wherein the size of the annular space enclosed by the three positioning clips is consistent with the inner diameter of the positioning sleeve, and the dimension of the outer edges of the three positioning clips is greater than the outer diameter of the positioning sleeve.

9. The flexible hollow anchor rod integrating digital monitoring according to claim 8, wherein the hole sealing sheath is made of rubber material.

10. A method for installing the flexible hollow anchor rod integrating digital monitoring according to claim 1 comprising the following steps:
step 1: drilling a stepped drill hole in a rock mass, wherein the stepped drill hole comprising a large-diameter section of drill holes proximal to the surface of the rock mass and a small-diameter section of drill holes distal to the surface of the rock mass, the pore diameter and length of the large-diameter section of drill holes match the pore diameter and length of the hole sealing sheath, and the pore diameter and length of the small-diameter section of drill holes match the pore diameter and length of the steel strand;
step 2: first, arranging the three fiber grating sensors whose length match the length of the steel strand evenly on the outer surface of the steel strand in the circumferential direction, and bonding each fiber grating sensor in the spiral mounting groove formed between every two adjacent steel wires, and embedding the three fiber output sections correspondingly connected to the three fiber grating sensors in the three strip-CANAL shaped through grooves on the hollow anti-torsion sleeve at the same time; then, sleeving the hole sealing sheath outside the hollow anti-torsion sleeve; next, fitting the anti-torsion tray around the left end of the hollow anti-torsion sleeve, so that the stop posts are located at a side close to the hole sealing sheath; finally, fitting the ribbed tray, the self-aligning ball head, the anti-wear gasket and the torque nut around the fastening section sequentially, so that the self-aligning ball head is embedded in the ball head positioning hole;
step 3: first, placing an anchoring agent in the stepped drill hole, then using the centering positioner fixed at the end of the flexible hollow rod body to press the anchoring agent and push the anchoring agent to the bottom of the stepped drill hole; next, starting an anchor rod drill to drive the torque nut to rotate and synchronously drive the flexible hollow rod body to rotate, and then using the three positioning clips on the centering positioner to stir the anchoring agent; driving the anchor rod drill to move further toward the bottom of the hole to evenly stir the anchoring agent while the flexible hollow rod body rotates; waiting for seconds after the anchor rod drill is driven to the bottom of the hole, so that the anchoring agent fully solidifies;
step 4: switching on the anchor rod drill again to destroy a pin piece on the torque nut to make the torque nut rotate toward the bottom of the hole along the first external thread structure on the fastening section and press against the anti-wear gasket and the self-aligning ball head, thereby driving the ribbed tray and the anti-torsion tray to move in the axial direction of the fastening section toward the bottom of the hole, so that the four stop posts on the anti-torsion tray are pressed against the rock wall, using the anti-torsion tray to drive the hole sealing sheath to move toward the bottom of the hole, and pushing the tapered section of the outer contour of the hole sealing sheath into the joint between the large-diameter drill hole and the small-diameter drill hole; in this process, positioning the hollow anti-torsion sleeve and the ribbed tray in the rotation direction by using the positioned anti-torsion tray, plugging the transition between the large-diameter drill hole and the small-diameter drill hole with the tapered section of the outer contour of the hole sealing sheath, and, at the same time, sealing the large-diameter drill hole with the continuous fluctuation section of the outer contour of the hole sealing sheath that has expanded in volume owing to a squeezing action;
step 5: withdrawing the anchor rod drill, then repeating the steps 1-4 to perform the installation operation of the flexible hollow anchor rod sequentially;
step 6: for each flexible hollow anchor rod, removing the grout stop plug from the hollow anti-torsion sleeve, mounting a grouting pipe at the core tube mounting hole at the axis of the fastening section, and grouting through the grouting pipe; wherein grouting is not carried out immediately after the installation of the flexible hollow anchor rod, because the factures in the surrounding rock of the roadway has not fully developed at this time; instead, grouting is carried out after the stress of the roadway is completely relieved and a new balance is achieved, at this time the fractures has developed to a certain degree but are not in communication with each other yet and the stability of the surrounding rock can be maintained; by controlling the grouting time accurately and utilizing a delayed grouting operation, the injected grout can flow through the core tube mounting hole, the hollow steel tube and the grout outlet on the hollow steel tube and enters the central cavity of the steel strand, and then the injected grout is filled through the grout passage on the steel strand into the space between the steel strand and the small-diameter section of drill holes; after the grouting, mounting the grout stop plug to the left end of the core tube mounting hole through thread-fitting to reset the grout stop plug, so as to effectively block the grout and close the fractures in the rock mass; and
step 7: connecting the three fiber output sections correspondingly connected to the three fiber grating sensors on each flexible hollow anchor rod to a fiber grating demodulator, so as to monitor the stress in each flexible hollow anchor rod with the fiber grating demodulator.
